(19) United States
(12) Patent Application Publication
(10) Pub. No.: US 2011/0307419 A1
(43) Pub. Date: Dec. 15, 2011

(54) POEM TO A LOVED ONE BUSINESS SYSTEMS AND METHODS

(76) Inventor: Darlene E. Potrykus, Philadelphia, PA (US)

(21) Appl. No.: 13/100,148

(22) Filed: May 3, 2011

Related U.S. Application Data
(60) Provisional application No. 61/354,386, filed on Jun. 14, 2010.

(51) Int. Cl. G06Q 90/00

(52) U.S. Cl. 705/500

(57) ABSTRACT

A system and method of monetizing a Poem To a Loved One including the steps of: providing at least one manufactured item that may be impressioned thereon having at least one indicia; impressionably printing the Poem To a Loved One on the manufactured item; distributing for sale the manufactured item having the Poem To a Loved One impressioned thereon; and selling the manufactured item(s) to create at least one monetization. The system may be monetized as a gift-kit including manufactured item(s) having indicia consisting of the Poem To a Loved One impressioned thereon, and a greeting card. The gift-kit is suitable for festive occasions such as Mother's Day, Christmas, Birthday or other such occasion(s).

### CROSS-REFERENCE TO RELATED APPLICATION

The present application is related to and claims priority from prior provisional application Ser. No. 61/354,386, filed Jun. 14, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of poetry and more specifically relates to providing a heartfelt poem that may be monetized by application to greeting cards, magnets, apparel and other similar accessories.

2. Description of the Related Art

Poetry is a mainstay of communication that may be used to artistically express heartfelt sentiments. Poetry has traditionally been the creating of literary art in which language is used for its aesthetic and evocative qualities in addition to, or in lieu of, its ‘apparent meaning’. Poetry may be written independently, as discrete poems, or may occur in conjunction with other arts, as in poetic drama, hymns, lyrics, or prose poetry.

Throughout history, mankind has expressed himself through poetry. Beautiful lyrical poems strike the hearts of listeners, offering the writer a simple, yet effective means of expressing various aspects of life, death, and love. Gifted individuals are able to convey deep seated feelings through their use of word combinations that resonate with our hearts and minds. Many times poetry may be written as a means of memorializing significant persons or events; however, poetry in and of itself may be difficult to monetize.

Various attempts have been made to solve the above-mentioned problems such as those found in U.S. Pat. Nos. 4,584,213; 5,004,271; 5,516,033; and 5,626,551. This prior art is representative of poetry commercialization. None of the above inventions and patents, taken either singly or in combination, is seen to describe the invention as claimed.

Ideally, a Poem To a Loved One business system and method should provide at least one heartfelt poem that may be monetized by application to greeting cards, magnets, and other similar accessories and, yet be a momento that is manufactured and distributed at a modest expense. Thus, a need exists for a Poem To a Loved One business system and method to avoid the above-mentioned problems.

### BRIEF SUMMARY OF THE INVENTION

In view of the foregoing disadvantages inherent in the known poetry and commercialization art, the present invention provides a novel Poem To a Loved One business system and method. The general purpose of the present invention, which will be described subsequently in greater detail is to provide at least one heartfelt poem that may be monetized by application to greeting cards, magnets, apparel, and other such similar accessories.

A method of monetizing a Poem To a Loved One is disclosed herein comprising the steps of: providing at least one manufactured item that may be impressioned thereon having at least one indicia; impressionably printing the Poem To A Loved One on the manufactured item; distributing for sale the manufactured item having the Poem To a Loved One impressioned thereon; and selling the manufactured item(s) to create at least one monetization for the creator of the work, and/or at least one wholesaler and/or at least one retailer.

The Poem To a Loved One within the present invention comprises words consisting of: you are as perfect as a rose, for you're beautiful and sweet, no dictionary can describe you as old, rather that you are seasoned with wisdom, and your heart is that of gold, you are a woman of strong character, warmth and love, sent to your children from heaven above, you are a friend to me uncomparable to any other, Why? Because God has made you my Mother.

In certain embodiments the manufactured item (available for sale) may comprise greeting cards; magnets; decorative plaques; dishes (such as plates or mugs or drinking cups); and apparel (such as t-shirts; sweatshirts). The indicia may be directly sewn onto the apparel; screen-printed; and/or appliquéd onto the user-preferred manufactured item. The indicia including the poem may be horizontally-oriented; vertically-oriented; and/or diagonally-oriented.

A gift-kit for a Poem To a Loved One is also disclosed herein comprising: at least one manufactured item having indicia consisting of words (of the above-mentioned Poem To a Loved One), and at least one greeting card. The gift-kit is suitable for festive occasions such as Mother's Day, Christmas, Birthday or other such occasion(s).

The present invention holds significant improvements and serves as a Poem To a Loved One business system and method. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Poem To a Loved One Business Systems and Methods, constructed and operative according to the teachings of the present invention.

FIG. 1 shows a perspective view illustrating a Poem to A Loved One according to an embodiment of the present invention.

FIG. 2 is a perspective view illustrating a Poem To a Loved One business system and method according to an embodiment of the present invention of FIG. 1.

FIG. 3 is a flowchart illustrating a method of monetizing the Poem To a Loved One business system and method according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to a monetization means and more particularly to a monetization means for poetry (poetic art) as used to improve the monetization of at least one heartfelt poem by application to greeting cards, magnets, and other similar accessories/manufactured items.

Poetry has a timeless appeal that may be appreciated for lifetimes to come. A Poem to A Loved One is a poem that may appeal to those who wish to express their love to their Mother. The Poem to a Loved One itself may be crafted using a variety of text styles and fonts, including but not limited to cursive or stylized lettering, and may be read horizontally, vertically, or diagonally across merchandise. Furthermore, the Poem to A Loved One may be applied to a wide variety of goods such as greeting cards, magnets, decorative plaques, t-shirts, and other objects that may be worn or presented as treasured gifts.

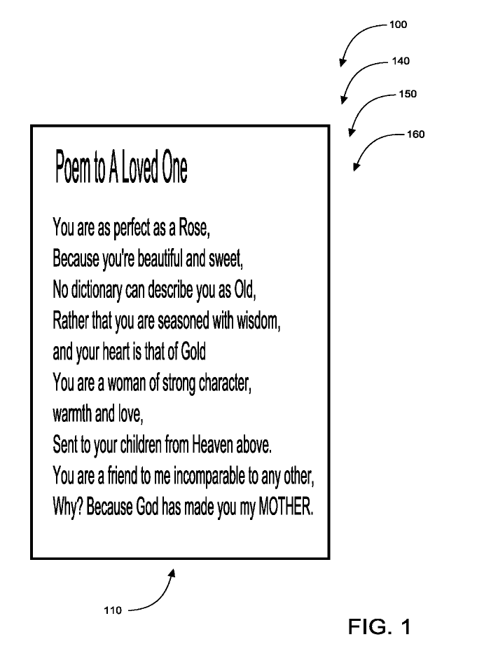

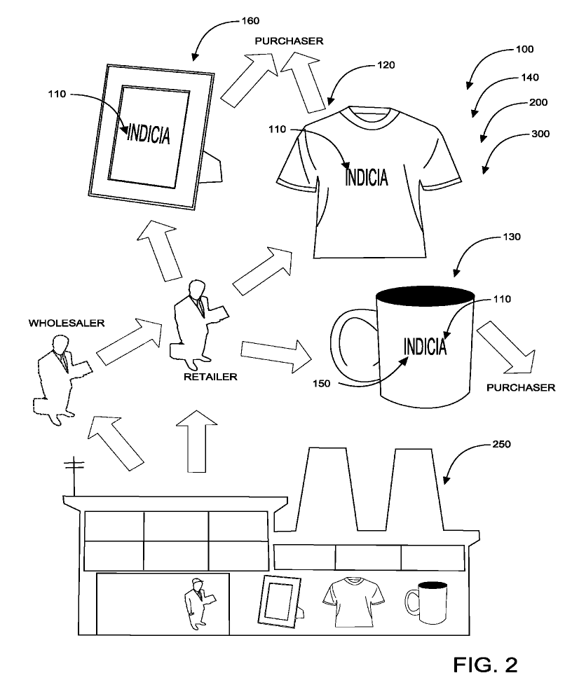

Referring more specifically to the drawings by numerals of reference there is shown in FIGS. 1 and 2 perspective views illustrating a Poem to A Loved One 110 according to an embodiment of the present invention in FIG. 1 and in FIG. 2, a perspective view illustrating a Poem To A Loved One business system and method 100 according to an embodiment of the present invention of FIG. 1.

Referring first to FIG. 1, Poem to a Loved One 110 consists of the following words:

You are as perfect as a Rose,

For you're beautiful and sweet,

No dictionary can describe you as Old,

Rather that you are seasoned with wisdom,

and your heart is that of Gold,

You are a woman of strong character,

warmth and love,

Sent to your children from Heaven above,

You are a friend to me uncomparable to any other,

Why? Because God has made you my MOTHER.

Referring also now to FIG. 2 alluding to Poem to A Loved One 110 which may be applied via at least one manufacturing process 250 to a wide variety of goods including greeting cards, magnets, decorative plaques 160, t-shirts 120, sweatshirts, mug(s) 130, dishes, and other like manufactured items 140 (some of which are shown for means of enablement). Upon reading this specification, it should be appreciated that, under appropriate circumstances, considering such issues as user preferences, design preference, structural requirements, marketing preferences, cost, available materials, technological advances, etc., other manufactured items 140 such as, for example, other items of apparel, other dishware items, postcards and other printed items, etc., may be sufficient.

The Poem to A Loved One 110 may further be designed using a variety of text styles and fonts, including cursive or stylized lettering (indicia 150), as previously mentioned and may be read, horizontally, vertically, or diagonally across merchandise. Designs may also be produced in a wide array of eye-catching colors, as well as standard black and white versions. Manufactured items 140 that bear Poem to A Loved One 110 may be adorned with virtually any number of decorative images which may add a fancy touch to the overall sentiment. For example hearts, flowers and other decorative images may be combined with indicia 150, as per purchaser-preference or manufacturer/retailer/wholesaler preference according to what he/she finds to best suit the market of such product. In certain circumstances a purchaser may custom order manufactured items 140 comprising different decorative images or combinations thereof.

Poem to A Loved One 110 may be applied to a wide variety of manufactured items 140 and in some embodiments might be screen-printed, appliquéd, or directly sewn onto merchandise. In other embodiments, colorful t-shirts 120 and sweatshirts (or other such apparel), imprinted with Poem to A Loved One 110 might be a perfect Mother's Day gift, offering both stylish casual wear and a tangible reminder of the love of one's children in one elegant piece. Further, presenting a sleek framed Poem to A Loved One 110 decorative plaque 160 on the occasion of a birthday may offer caring sons and daughters a simple means of showing their Mother how much they care for her while providing the recipient an elegant showpiece for the home. Furthermore, items bearing Poem to A Loved One 110 may be a favored present for virtually any Christmas, birthday or anniversary celebration. Printed on a variety of accessories and apparel items, Poem to A Loved One 110 is a gentle poem that may provide consumers with a novel means of expressing love and is suitable for many occasions as aforementioned.

Gift-kit 200 for a Poem To a Loved One 110 (as available for ultimate distribution and sale to purchaser via monetization means described herein) may comprise: at least one manufactured item 140 having indicia 150 consisting of words (of the above-mentioned Poem To a Loved One), and at least one greeting card. Gift-kit 200 may include manufactured item(s) comprising at least one apparel; and/or a drinking cup; and/or decorative plaques 160; and/or dishes; and/or magnets; and/or framed pictures in combination with a greeting card (not shown). Gift-kit 200 may be suitable for festive occasions such as Mother's Day, Christmas, Birthday or other such occasion(s). Gift-kit 200 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, different color combinations, different text; components may be sold separately, etc., may be sufficient.

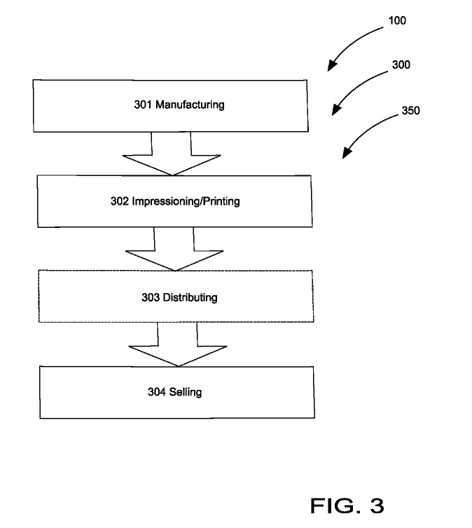

FIG. 3 is a flowchart 350 illustrating a method of monetizing 300 the Poem To a Loved One business system and method 100 according to an embodiment of the present invention of FIGS. 1-2.

A method of monetizing 300 Poem To a Loved One 110 (using Poem To a Loved One business system and method 100) may comprise the steps of: step one 301 providing at least one manufactured item 140 that may be impressioned thereon having at least one indicia 150; step two 302 impressionably printing (or otherwise affixing) Poem To a Loved One 110 on manufactured item 140 via at least one manufacturing process 250; step three 303 distributing for sale manufactured item 140 having Poem To A Loved One 110 impressioned thereon; and step four 304 selling manufactured item(s) to create at least one monetization (via wholesaler→retailer→purchaser or other suitable commercial chain). Poem To a Loved One comprising words (indicia 150) consisting of (as previously recited), you are as perfect as a rose, for you're beautiful and sweet, no dictionary can describe you as old, rather that you are seasoned with wisdom, and your heart is that of gold, you are a woman of strong character, warmth and love, sent to your children from heaven above, you are a friend to me uncomparable to any other, Why? Because God has made you my mother.

Manufactured items 140 may comprise at least of greeting cards; magnets; decorative plaques 160; dishes; drinking cup; apparel; t-shirts 120; and/or sweatshirts. Indicia 150 may be directly sewn onto apparel. Alternately, indicia 150 may be screen-printed onto manufactured item 140. In other applications indicia 150 may be appliquéd onto manufactured item 140. Indicia 150 may be horizontally-oriented, and/or vertically-oriented, and/or diagonally-oriented.

It should be noted that step 303 is an optional step and may not be implemented in all cases. Optional steps of method 300 are illustrated using dotted lines in FIG. 3 so as to distinguish them from the other steps of method 300.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of monetizing a Poem To a Loved One comprising the steps of:
providing at least one manufactured item that may be impressioned thereon having at least one indicia;
impressionably printing said Poem To a Loved One on said manufactured item;
said Poem To a Loved One comprising words consisting of,
you are as perfect as a rose,
for you're beautiful and sweet,
no dictionary can describe you as old,
rather that you are seasoned with wisdom,
and your heart is that of gold,
you are a woman of strong character,
warmth and love,
sent to your children from heaven above,
you are a friend to me uncomparable to any other,
Why? Because God has made you my Mother;
distributing for sale said manufactured item having said Poem To a Loved One impressioned thereon; and
selling said manufactured item(s) to create at least one monetization.

2. The method of monetizing a Poem To a Loved One of claim 1 wherein said manufactured item comprises greeting cards.

3. The method of monetizing a Poem To a Loved One of claim 1 wherein said manufactured item comprises magnets.

4. The method of monetizing a Poem To a Loved One of claim 1 wherein said manufactured item comprises decorative plaques.

5. The method of monetizing a Poem To a Loved One of claim 1 wherein said manufactured item comprises dishes.

6. The method of monetizing a Poem To a Loved One of claim 1 wherein said manufactured item comprises a drinking cup.

7. The method of monetizing a Poem To a Loved One of claim 1 wherein said manufactured item comprises apparel.

8. The method of monetizing a Poem To a Loved One of claim 7 wherein said apparel comprises t-shirts.

9. The method of monetizing a Poem To a Loved One of claim 7 wherein said apparel comprises sweatshirts.

10. The method of monetizing a Poem To a Loved One of claim 7 wherein said indicia is directly sewn onto said apparel.

11. The method of monetizing a Poem To a Loved One of claim 1 wherein said indicia is screen-printed onto said manufactured item.

12. The method of monetizing a Poem To a Loved One of claim 1 wherein said indicia is appliquéd onto said manufactured item.

13. The method of monetizing a Poem To a Loved One of claim 1 wherein said indicia is horizontally-oriented.

14. The method of monetizing a Poem To a Loved One of claim 1 wherein said indicia is vertically-oriented.

15. The method of monetizing a Poem To a Loved One of claim 1 wherein said indicia is diagonally-oriented.

16. A gift-kit for a Poem To a Loved One comprising:
at least one manufactured item having indicia consisting of words,
you are as perfect as a rose,
for you're beautiful and sweet,
no dictionary can describe you as old,
rather that you are seasoned with wisdom,
and your heart is that of gold,
you are a woman of strong character,
warmth and love,
sent to your children from heaven above,
you are a friend to me uncomparable to any other,
why? because God has made you my mother; and
at least one greeting card.

17. The gift-kit of claim 16 wherein said manufactured item comprises apparel; and/or a drinking cup; and/or decorative plaques; and/or dishes; and/or magnets; and/or framed pictures in combination with said greeting card.
